(19) United States
(12) Patent Application Publication
(10) Pub. No.: US 2008/0001816 A1
(43) Pub. Date: Jan. 3, 2008

(54) Portable wireless earphone apparatus with a global positioning system

(76) Inventors: Bily Wang, Hsin Chu City (TW); Chong-Kai Wang, Changhua City (TW); Chung-Hsien Su, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/477,492

(22) Filed: Jun. 30, 2006

(51) Int. Cl. G08B 1/08

(52) U.S. Cl. 342/357.09; 340/539.13

(57) ABSTRACT

A portable wireless earphone apparatus with a global positioning system integrates a wireless earphone with a wireless global positioning system to create a personnel portable apparatus. The user can carry this apparatus and access a Bluetooth wireless cell phone. When the user is driving, the apparatus can be used as a GPS Bluetooth wireless receiver. The apparatus has more than two functions. The apparatus also provides the functions of GPS tracking record, GPS traveling location record, GPS special traveling location record and a portable flash disc. The portable wireless earphone apparatus with a global positioning system includes a microcontroller, a GPS module, a Bluetooth wireless module, a memory module, a display module, a sound output module, an input device and a power supply module.

### BACKGROUND OF THE INVENTION

1. Field of the Invention

The present invention relates to a portable wireless earphone apparatus with a global positioning system. In particular, this invention relates to an apparatus having a global positioning system technology and Bluetooth wireless technology.

2. Description of the Related Art

Global positioning system (GPS) is a satellite positioning system and was developed by the Ministry of National Defense, USA. It uses satellites to provide precise orientation to a GPS receiver. The information from the satellite is then decoded into a longitude position and a latitude position. The decoded data is transmitted to a PC, a PDA or a smart phone for displaying location information and providing orientation information to a user. For example, a car navigating system utilizes the global positioning system and a PDA or a car video-audio system to provide navigating information to a driver.

Furthermore, due to the development of Bluetooth wireless technology and cell phones, Bluetooth earphones integrated with a Bluetooth capable cell phone have lately become increasingly popular with consumers. The user can use a small and exquisite earphone to use the cell phone via Bluetooth wireless headset communication protocol. The user does not need to lift the cell phone to their ear.

The conventional Bluetooth wireless GPS receiver is a navigating apparatus that is connected to a PDA or a smart phone with Bluetooth. The PGS receiver transmits GPS information to a PDA via Bluetooth SPP communication protocol. The GPS information is combined with mapping data in the PDA or smart phone to provide navigating information.

Currently, business people or car drivers are the most common users of Bluetooth GPS and Bluetooth wireless earphones. However, obviously it is inconvenient for a user to carry both two apparatuses at the same time.

### SUMMARY OF THE INVENTION

One particular aspect of the present invention is to provide a portable wireless earphone apparatus with a global positioning system. The portable wireless earphone apparatus integrates a wireless earphone with a wireless global positioning system to create a personnel portable apparatus. The user carries this apparatus and can access their Bluetooth wireless cell phone. When the user is driving car, the apparatus can be used as a GPS Bluetooth wireless receiver. The apparatus has more than two functions and is very convenient for the user.

Another particular aspect of the present invention is to provide a portable wireless earphone apparatus with a global positioning system. The portable wireless earphone apparatus integrates a wireless earphone with a wireless global positioning system to create a personnel portable apparatus. The apparatus also provides a GPS tracking record, a GPS traveling location record and a GPS special traveling location record.

A further particular aspect of the present invention is to provide a portable wireless earphone apparatus with a global positioning system. The portable wireless earphone apparatus integrates a wireless earphone with a wireless global positioning system to create a personnel portable apparatus. The apparatus also is used as a portable flash disc.

Another further particular aspect of the present invention is to provide a portable wireless earphone apparatus with a global positioning system. The portable wireless earphone apparatus integrates a wireless earphone with a wireless global positioning system to create a personnel portable apparatus. The apparatus also provides a dual-mode function. The portable wireless earphone apparatus is used as a Bluetooth wireless GPS and a G-mouse connected with a data transmission line.

The portable wireless earphone apparatus with a global positioning system includes a microcontroller, a GPS module, a Bluetooth wireless module, a memory module, a display module, a sound output module, an input device and a power supply module. The microcontroller is used for controlling the operation of the portable wireless earphone apparatus. The GPS module is electrically connected with the microcontroller and has a GPS receiver for receiving satellite signals. The Bluetooth wireless module is electrically connected with the microcontroller for providing a wireless communication and a wireless data transmission. The memory module is electrically connected with the microcontroller for recording and storing data. The display module is electrically connected with the microcontroller for displaying GPS information and a caller ID of the Bluetooth earphone. The sound output module is electrically connected with the microcontroller and the Bluetooth wireless module for outputting sound. The input device is electrically connected with the microcontroller for adjusting the volume of the earphone, recording positioning location or navigating and selecting the functions provided on the function menu of the apparatus. The power supply module is used for providing the electrical power needed for each module of the wireless portable earphone apparatus.

The portable wireless earphone apparatus with a global positioning system of the present invention further comprises a GPS tracking recorder. The GPS tracking recorder is controlled by the microcontroller to store orientation tracking information of the GPS into the memory module. Furthermore, the portable wireless earphone apparatus with a global positioning system of the present invention further comprises a GPS traveling location recorder. The GPS traveling location recorder is controlled by the microcontroller to store traveling location information, including orientation and time, into the memory module. The portable wireless earphone apparatus with a global positioning system of the present invention further comprises a portable flash disc module. The storage space of the portable flash disc module is located in the memory module and the portable wireless earphone apparatus is used as a portable flash disc.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the best embodiment of the portable wireless earphone apparatus with a global positioning system of the present invention; and

FIG. 2 is a schematic diagram of the appearance of the portable wireless earphone apparatus with a global positioning system of the present invention.

### DETAILED DESCRIPTION OF THE PREFERRED EMBODIMENTS

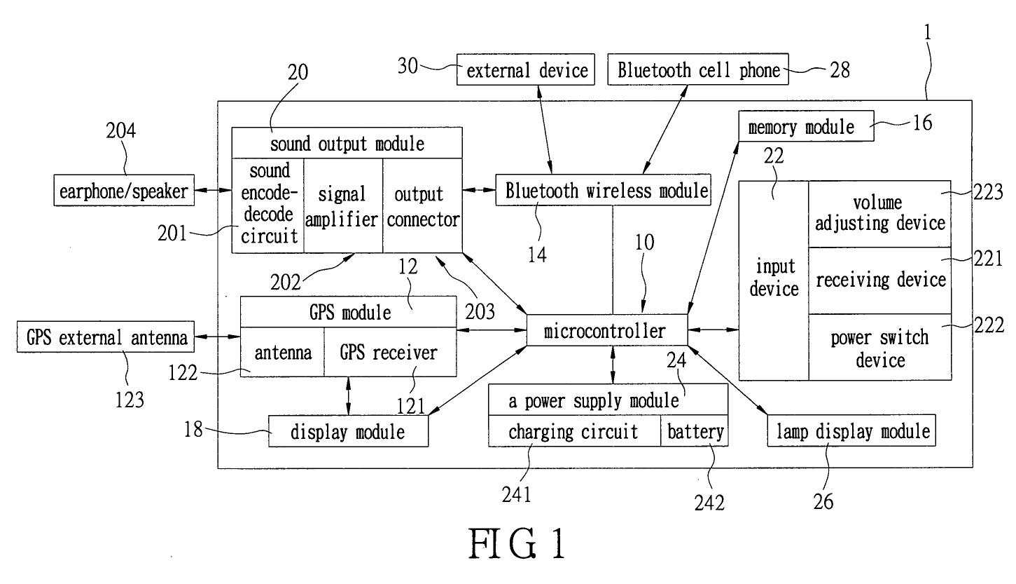

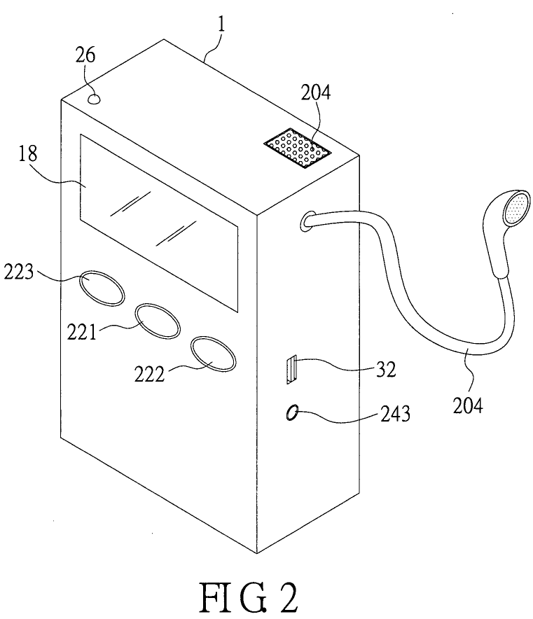

Reference is made to FIGS. 1 and 2. FIG. 1 shows a schematic diagram of the best embodiment of the portable wireless earphone apparatus with a global positioning system of the present invention. FIG. 2 shows a schematic diagram of the appearance of the portable wireless earphone apparatus with a global positioning system of the present invention. The portable wireless earphone apparatus with a global positioning system 1 includes a microcontroller 10, a GPS module 12, a Bluetooth wireless module 14, a memory module 16, a display module 18, a sound output module 20, an input device 22 and a power supply module 24.

The microcontroller 10 is used for controlling the operation of the portable wireless earphone apparatus. The GPS module 12 is electrically connected with the microcontroller 10 and has a GPS receiver 121 for receiving satellite signals. Satellite signals are received via a GPS antenna and are decoded and calculated to output positioning data to the microcontroller 10. The GPS module 12 further comprises an external antenna 123 that is connected to the GPS receiver 121 by a connector for enhancing the effect of receiving signals.

The Bluetooth wireless module 14 is electrically connected with the microcontroller 10 for providing wireless communication and wireless data transmission. By using the Bluetooth wireless method, sound signals or caller ID of a Bluetooth cell phone are received and transmitted. Furthermore, an external device 30, such as a PDA, a smart phone or a computer, can be connected to the Bluetooth wireless module 14 via the Bluetooth wireless method for receiving the GPS positioning data. The external device 30 displays GPS positioning data to form a car navigating system. The Bluetooth wireless module 14 has a dual-mode function that includes Bluetooth wireless linking function and a G-mouse function connected by a dada transmission line. Via the above two methods, the Bluetooth wireless module 14 is connected to the external device 30.

The memory module 16 is electrically connected with the microcontroller 10 for recording and storing data, including storing system firmware, or GPS recorded data, such as special traveling location record. The portable wireless earphone apparatus with a global positioning system 1 of the present invention further comprises a GPS tracking recorder. The GPS tracking recorder is controlled by the microcontroller 10 to store orientation tracking information of the GPS into the memory module 10. Furthermore, the portable wireless earphone apparatus with a global positioning system 1 of the present invention further comprises a GPS traveling location recorder. The GPS traveling location recorder is controlled by the microcontroller 10 to store traveling location information, including orientation and time, into the memory module 16. The portable wireless earphone apparatus with a global positioning system 1 of the present invention further comprises a portable flash disc module. The storage space of the portable flash disc module is located in the memory module 16 and the portable wireless earphone apparatus is used as a portable flash disc and includes a USB interface. The memory module is composed of flash memory.

The display module 18 is electrically connected with the microcontroller 10 for displaying GPS information and a caller ID of the Bluetooth earphone. The sound output module 20 is electrically connected with the microcontroller 10 and the Bluetooth wireless module 14 for outputting sound. The sound output module 20 includes a sound encode-decode circuit 201, a signal amplifier 202 and an output connector 203. The sound output module 20 can be an amplifier, such as a speaker. The sound output module 20 further includes an earphone hole. The display module 18 outputs the sound signals via an earphone/speaker.

The input device 22 is electrically connected with the microcontroller 10 for adjusting the volume of the earphone. The input device 22 includes a receiving device 221, a power switch device 222 and a volume adjusting device 223. The receiving device 221, the power switch device 222 and the volume adjusting device 223 respectively provide the functions of receiving a call, switching the power supply and adjusting the volume. Their type is not limited. It can be a pressed-key type, a turning type, a knob type, a cross waving rod or other type. For example, the power switch device 222 is a turning type power switch; the volume adjusting device 223 is a rotating disc turning knob with a circular shape. The input device 22 is also used for recording positioning location or navigating and selecting the functions provided on the function menu of the apparatus.

The power supply module 20 is used for providing the electrical power needed for each module of the wireless portable earphone apparatus 1. The power supply module 20 includes a charging circuit 241 and a battery 242. The battery 242 can be a rechargeable battery, an alkaline battery or a dry battery. The power supply module 20 further includes an external power connector 243. The power supply module 20 provides electrical power for the wireless portable earphone apparatus 1 and has a charging power function.

The portable wireless earphone apparatus with a global positioning system 1 further comprises a lamp display device 26 electrically connected to the microcontroller 10 for displaying the status of the battery power, GPS and Bluetooth. The portable wireless earphone apparatus with a global positioning system 1 further comprises a data transmission interface 32, such as a USB interface, for transmitting data with the external device.

The microcontroller 10 in the portable wireless earphone apparatus with a global positioning system 1 can be a standalone module. Alternatively it can be embedded in the Bluetooth wireless module 14 or the GPS module 12.

The memory module of the portable wireless earphone apparatus with a global positioning system 1 records special traveling location records, such as gas stations, government organizations or speed traps. When a user is close to the special traveling location, the display module 18 displays the traveling location information and the sound output module 20 outputs sound to alert the user.

When the GPS tracking record function is started, the memory module 16 of the portable wireless earphone apparatus with a global positioning system 1 records the GPS positioning data, including location, speed, orientation, time, etc. The user can set the data recorded format (such as recording one time within a fixed period, or recording one time within a fixed distance) via keys or software. After the data is stored, the tracking information can be outputted via the data transmission line and be analyzed by software.

When the GPS tracking record function is started, the user starts the tracking record function by pressing the function key. The memory module 16 of the portable wireless earphone apparatus with a global positioning system 1 records the position and time of the present location. The user can obtain the data from the memory module 16 via software.

When the user plugs earphones into the earphones hole, the portable wireless earphone apparatus with a global positioning system 1 links to a Bluetooth cell phone and is used as a Bluetooth wireless earphone. The caller ID is displayed on the display module 18. The keys on the portable wireless earphone apparatus with a global positioning system 1 are used for adjusting the volume and receiving a call.

When the user puts the portable wireless earphone apparatus with a global positioning system 1 at an appropriate location, and links to an external device, such as a PDA, and starts the Bluetooth receiving port of the external device. The navigating information is transmitted to the PDA via a SPP communication protocol for navigating.

The portable wireless earphone apparatus with a global positioning system 1 of the present invention integrates GPS with Bluetooth technology to provide a GPS function and a Bluetooth earphone function. The portable wireless earphone apparatus with a global positioning system 1 of the present invention also provides GPS tracking record, GPS traveling location record, special traveling location record and can be used as a portable flash disc.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A portable wireless earphone apparatus with a global positioning system, comprising:
a microcontroller, for controlling the operation of the portable wireless earphone apparatus;
a GPS module, electrically connected with the microcontroller, and having a GPS receiver for receiving satellite signals;
a Bluetooth wireless module, electrically connected with the microcontroller, for providing wireless communication and wireless data transmission;
a memory module, electrically connected with the microcontroller for recording and storing data;
a display module, electrically connected with the microcontroller, for displaying GPS information and caller ID of the Bluetooth earphone;
a sound output module, electrically connected with the microcontroller and the Bluetooth wireless module, for outputting sound;
an input device, electrically connected with the microcontroller, for adjusting the volume of the earphone, recording positioning location or navigating and selecting the functions provided on the function menu of the apparatus, and;
a power supply module, used for providing electrical power needed for each module of the wireless portable earphone apparatus.

2. The portable wireless earphone apparatus with a global positioning system as claimed in claim 1, further comprising a lamp display device, electrically connected to the microcontroller, for displaying the status of battery power, GPS and Bluetooth.

3. The portable wireless earphone apparatus with a global positioning system as claimed in claim 1, wherein the GPS module further comprises a built-in antenna located in the GPS receiver.

4. The portable wireless earphone apparatus with a global positioning system as claimed in claim 1, wherein the GPS module further comprises an external antenna connected to the GPS receiver.

5. The portable wireless earphone apparatus with a global positioning system as claimed in claim 1, wherein the sound output module comprises a sound encode-decode circuit, a signal amplifier and an output connector.

6. The portable wireless earphone apparatus with a global positioning system as claimed in claim 1, wherein the sound output module is a speaker.

7. The portable wireless earphone apparatus with a global positioning system as claimed in claim 1, wherein the sound output module further comprises an earphones hole.

8. The portable wireless earphone apparatus with a global positioning system as claimed in claim 1, wherein the power supply module includes a charging circuit and a battery.

9. The portable wireless earphone apparatus with a global positioning system as claimed in claim 8, wherein the battery is a rechargeable battery, an alkaline battery or a dry battery.

10. The portable wireless earphone apparatus with a global positioning system as claimed in claim 1, wherein the power supply comprises an external power connector.

11. The portable wireless earphone apparatus with a global positioning system as claimed in claim 1, wherein the microcontroller is embedded in the Bluetooth wireless module.

12. The portable wireless earphone apparatus with a global positioning system as claimed in claim 1, wherein the microcontroller is embedded in the GPS module.

13. The portable wireless earphone apparatus with a global positioning system as claimed in claim 1, wherein the input device further comprises a receiving device.

14. The portable wireless earphone apparatus with a global positioning system as claimed in claim 1, wherein the input device further comprises a power switch device.

15. The portable wireless earphone apparatus with a global positioning system as claimed in claim 14, wherein the power switch device is a turning-type power switch.

16. The portable wireless earphone apparatus with a global positioning system as claimed in claim 1, further comprising a data transmission interface.

17. The portable wireless earphone apparatus with a global positioning system as claimed in claim 16, wherein the data transmission interface is a USB port.

18. The portable wireless earphone apparatus with a global positioning system as claimed in claim 1, wherein the memory module further comprises special traveling location records.

19. The portable wireless earphone apparatus with a global positioning system as claimed in claim 18, wherein the display module displays the information of the traveling location when the apparatus is close to the special traveling location recorded in the memory module.

20. The portable wireless earphone apparatus with a global positioning system as claimed in claim 18, wherein the sound output module outputs a sound to alert a user when the apparatus is close to the special traveling location recorded in the memory module.

21. The portable wireless earphone apparatus with a global positioning system as claimed in claim 1, further comprising a GSP tracking recorder.

22. The portable wireless earphone apparatus with a global positioning system as claimed in claim 21, wherein the GSP tracking recorder stores the tracking information of the GPS into the memory module.

23. The portable wireless earphone apparatus with a global positioning system as claimed in claim 1, further comprising a GSP traveling location recorder.

24. The portable wireless earphone apparatus with a global positioning system as claimed in claim 23, wherein the wherein the GSP traveling location recorder stores the orientation and time of the traveling location in the memory module

25. The portable wireless earphone apparatus with a global positioning system as claimed in claim 1, further comprising a portable flash disc.

26. The portable wireless earphone apparatus with a global positioning system as claimed in claim 25, wherein the storage space of the portable flash disc is located in the memory module.

27. The portable wireless earphone apparatus with a global positioning system as claimed in claim 25, further comprising a USB interface.

28. The portable wireless earphone apparatus with a global positioning system as claimed in claim 1, wherein the memory module is a flash memory.

29. The portable wireless earphone apparatus with a global positioning system as claimed in claim 1, wherein the Bluetooth wireless module has a dual-mode function, including a Bluetooth wireless linking function and a G-mouse function connected with a data transmission line.

30. A portable wireless earphone apparatus with a global positioning system, comprising:
a microcontroller, for controlling the operation of the portable wireless earphone apparatus;
a GPS module, electrically connected with the microcontroller, and having a GPS receiver for receiving satellite signals;
a Bluetooth wireless module, electrically connected with the microcontroller, for providing wireless communication and wireless data transmission;
a memory module, electrically connected with the microcontroller for recording and storing data;
an earphone module, electrically connected with the microcontroller and the Bluetooth wireless module, for connecting with a earphone and linking to a Bluetooth cell phone via the Bluetooth wireless module;
a receiving module, electrically connected with the microcontroller, for receiving a call; and
a power supply module, used for providing electrical power needed for each module of the wireless portable earphone apparatus.

31. The portable wireless earphone apparatus with a global positioning system as claimed in claim 30, wherein the GPS module further comprises a built-in antenna located in the GPS receiver.

32. The portable wireless earphone apparatus with a global positioning system as claimed in claim 30, wherein the GPS module further comprises an external antenna connected to the GPS receiver.

33. The portable wireless earphone apparatus with a global positioning system as claimed in claim 30, wherein the microcontroller is embedded in the Bluetooth wireless module.

34. The portable wireless earphone apparatus with a global positioning system as claimed in claim 30, wherein the microcontroller is embedded in the GPS module.

35. The portable wireless earphone apparatus with a global positioning system as claimed in claim 30, wherein the Bluetooth wireless module has a dual-mode function, including a Bluetooth wireless linking function and a G-mouse function connected with a data transmission line.

36. The portable wireless earphone apparatus with a global positioning system as claimed in claim 30, further comprising a portable flash disc.

37. The portable wireless earphone apparatus with a global positioning system as claimed in claim 36, wherein the storage space of the portable flash disc is located in the memory module.

38. The portable wireless earphone apparatus with a global positioning system as claimed in claim 36, further comprising a USB interface.

39. The portable wireless earphone apparatus with a global positioning system as claimed in claim 30, wherein the memory module is a flash memory.
